(19) United States
(12) Patent Application Publication
(10) Pub. No.: US 2009/0123818 A1
(43) Pub. Date: May 14, 2009

(54) BATTERY CASE HAVING RETAINING FUNCTION

(76) Inventor: Yu-Huei HUANG, Chungho City (TW)

Correspondence Address: SINORICA, LLC, 528 FALLSGROVE DRIVE, ROCKVILLE, MD, 20850, US

(21) Appl. No.: 12/197,346

(22) Filed: Aug. 25, 2008

(30) Foreign Application Priority Data
Nov. 9, 2007 (TW) 096218900

(51) Int. Cl. H01M 2/10

(52) U.S. Cl. 429/98

(57) ABSTRACT

The present invention relates a battery case having retaining function, comprises: a case member composed by a bottom wall, two lateral walls, a front wall and a rear wall so as to form a quadrangular space; an electrode sheet set composed by at least one negative terminal and at least one positive terminal, the positive and the negative terminals are oppositely and respectively provided on the inner sides of the two lateral walls according to the circuit layout, wherein one of the negative terminals and one of the positive terminals are respectively connected to a connecting wire which is exposed outside of the case member; a retaining structure composed by two connecting tenons, a neck section is respectively formed between each of the connecting tenons and the corresponding lateral wall, and the free end of each of the neck sections is provided with a mounting section with a size larger and wider than the neck section for being rapidly combined and retained on an object to be retained.

### BACKGROUND OF THE INVENTION

1. Field of the Invention

The present invention relates to a battery case, more particularly to a battery case having retaining function, by providing a retaining structure to the battery case, the battery case can be rapidly combined with an object to be retained.

2. Description of Related Art

The development of batteries has been a long history, by saving energy into a column-shaped member, the column-shaped member can be served to provide energy when needed, so this is a breakthrough from the limitation of the conventional fixed energy source and electronic goods provided with batteries can be portable.

An apparatus for accommodating batteries is therefore invented; most batteries are integratedly provided with electronic goods, e.g. a toy, a hand-held radio or a flashlight, in a few cases batteries are separately provided; or a battery case for charging batteries, in other words after rechargeable batteries are received in the battery case, the battery case is connected to an AC power source, after the power is rectified and the voltage thereof is lowered, then the rechargeable batteries are charged.

The feature of the battery cases mentioned above is that most circuits are in series, take a convention battery case for instance, two batteries are adjacently provided in the convention battery case as a set. As shown in FIG. 1, which is a structure of a convention battery case, an electrode sheet set composed by two negative terminals 101 and two positive terminals 102 is provided inside a case member 10, and one of the negative terminals 101 and the positive terminal 102 adjacently provided are respectively provided with a connecting wire for being externally connected, and batteries can be received in an accommodating chamber 103 of the case member 10, the space between the positive terminals 102 and the corresponding negative terminals 101 is served to received and position batteries. If the battery case is desired to be retained on an object to be retained, e.g. a printed circuit board, at least a through hole 104 is provided at a bottom wall of the case member 10 and a conventional connecting unit 105, e.g. a screw, is served to respectively pass through the through holes 104 for retaining the battery case on the object to be retained. A dual-sided adhesive tape can be provided on a bottom surface of the battery case for being adhered to the object to be retained.

The above mentioned retaining methods for a battery case can achieve the expected retaining effect, but when being assembled, more human power and working hours are required and at least one exposed screw is easily to be seen in the battery case that may effect the viewing sensation, therefore such arts are not good enough and need to be improved.

### SUMMARY OF THE INVENTION

The applicant of the present invention has devoted himself to design and commercially distribute electronic goods, with a hope to overcome the disadvantages that screws are adopted and served to retain a battery case on an object to be retained, and he wishes to develop a novel art that the battery case itself has a retaining function for being rapidly combined with an object to be retained, after try and error, the present invention “Battery case having retaining function” is provided.

One object of the present invention is to respectively provide a retaining structure on two lateral walls of a battery case, the retaining structures is composed by two connecting tenons, and a neck section is defined between each of the connecting tenons and the corresponding lateral wall, the free end of each of the neck sections is provided with a mounting section with a size larger and wider than the neck section for being rapidly combined and retained on an object to be retained.

For achieving the object mentioned above, an art provided by the present invention is to provide a battery case having retaining function, comprises: a case member composed by a bottom wall, two lateral walls, a front wall and a rear wall so as to form a quadrangular space; an electrode sheet set composed by at least one negative terminal and at least one positive terminal, the positive and the negative terminals are oppositely and respectively provided on the inner sides of the two lateral walls according to the circuit layout, wherein one of the negative terminals and one of the positive terminals are respectively connected to a connecting wire which is exposed outside of the case member; a retaining structure composed by two connecting tenons, each of the connecting tenons includes a neck section integratedly and downwardly extended from the corresponding lateral wall, and the free end of each of the neck sections is provided with a mounting section with a size larger and wider than the neck section; by mounting each of the connecting tenons into preset holes of an object to be retained, a retaining effect is obtained.

Another art provided by the present invention is to provide a battery case having retaining function, comprises: a case member composed by a bottom wall, two lateral walls, a front wall and a rear wall so as to form a quadrangular space, and the bottom end of each of the lateral walls is inwardly provided with a hollow hole; an electrode sheet set composed by at least one negative terminal and at least one positive terminal, the positive and the negative terminals are oppositely and respectively provided on the inner sides of the lateral walls according to the circuit layout, wherein one of the negative terminals and one of the positive terminals are respectively connected to a connecting wire which is exposed outside of the case member; a retaining structure composed by two connecting tenons, each of the connecting tenons is provided in the corresponding hollow hole of the lateral wall, a neck section of each of the connecting tenons is served to connect to the corresponding lateral wall provided on top of the hollow hole, the free end below each of the neck sections is respectively provided with a mounting section with a size larger and wider than the neck section, a gap is formed respectively between the hollow hole and the two ends of the mounting section; by buckling plural buckling tenons preset on an object to be retained to the concave space defined between the mounting section and the neck section, a retaining effect is obtained.

### BRIEF DESCRIPTION OF THE DRAWINGS

FIG. 1 is a 3D view of a conventional battery case;

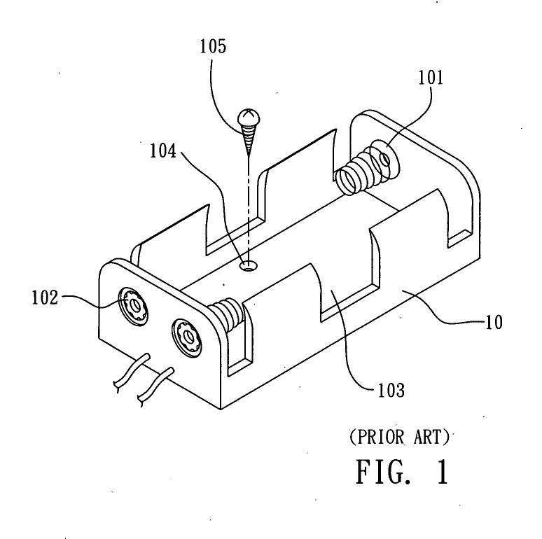

FIG. 2 is a 3D view of a battery case of one embodiment provided by the present invention;

FIG. 3 is a 3D view of the battery case of one embodiment provided by the present invention viewed from another angle;

FIG. 4 is a 3D view of a battery case of another embodiment provided by the present invention.

### DETAILED DESCRIPTION OF THE PREFERRED EMBODIMENT

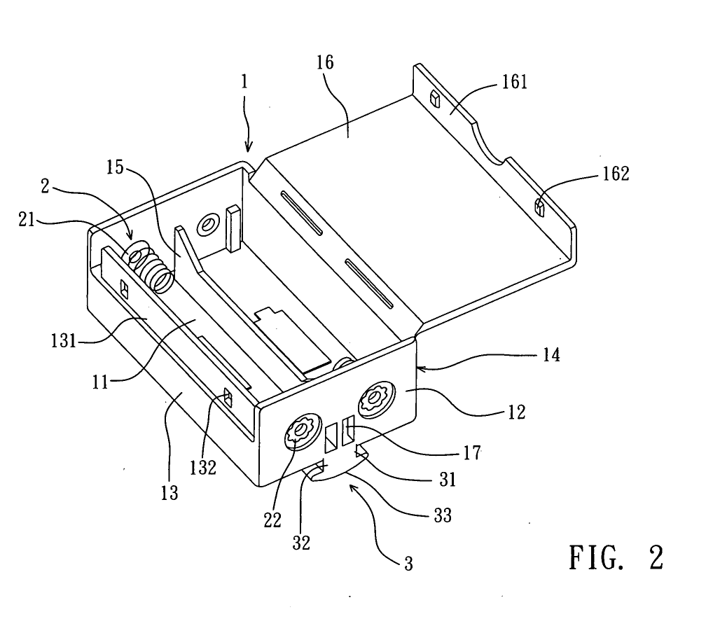

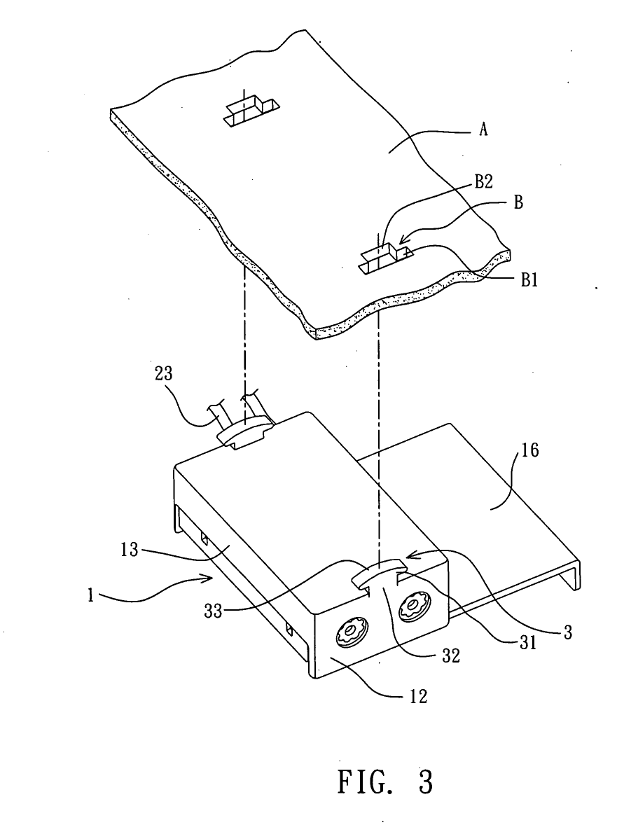

As shown in FIG. 2 and FIG. 3, the battery case having retaining function provided by the present invention is composed by a case member 1, an electrode sheet set 2 and a retaining structure 3.

The case member 1 is a semi-sealed quadrangular shell body, two ends of a bottom wall 11 is respectively and uprightly provided with a lateral wall 12, an end section of each of the lateral walls 12 is transversally and respectively connected to a front wall 13 and a rear wall 14, so a quadrangular accommodating space is obtained for receiving batteries. For separating two adjacent batteries, at least a partition rib 15 is provided between two lateral walls 12. As shown in FIG. 2, the case member 1 can be served as a sealed battery case, the top end of the rear wall 14 is connected to a flexible top cover 16, a vertical bending edge 161 is provided at the outer end of the top cover 16, when the top cover 16 is covered on top of the opening portion of the case member 1, the bending edge 161 is in contact with a concave section 131 provided on the top end of the front wall 13; with at least a buckling member provided between the concave section 131 and the bending edge 161, for example at least a buckling tenon 162 provided in the inner side of the bending edge 161 is buckled on a buckling hole 132 provided on the concave section 131 with respect to the buckling tenon 162, so the open portion of the case member 1 is sealed by the top cover 16 so as to form a sealed battery case. One of the two lateral walls 12 can be provided with two wire slots 17 for allowing connecting wires connected to the electrode sheet set 2 pass through.

The electrode sheet set 2 is composed by at least one negative terminal 21 and at least one positive terminal 22, as shown in FIG. 2, which is a battery case in which two batteries are adjacently arranged as a set, according to the actual needs the battery case can be composed by more than two batteries adjacently arranged as a set; for obtaining a series circuit, one of the negative terminals 21 and one of the positive terminals 22 are respectively provided on the same inner side of one of the lateral walls 12 and the other negative terminal 21 and the other positive terminal 22 are provided on the other inner side of the other lateral wall 12, then one of the negative terminals 21 provided on one of the lateral walls 12 is connected to the positive terminal 22 provided on the same lateral wall 12so as to form a circuit, the other positive terminal 22 and the other negative terminal 21 provided on the other lateral wall 12 are respectively connected to a connecting wire 23 that passes through the corresponding wire slot 17 of the lateral wall 12. The method of arranging the electrode sheet set 2 is a conventional art therefore will not be further described hereinafter.

The feature of the present invention is that a retaining structure 3 is provided on the two lateral walls 12 of the case member 1, as shown in FIG. 2, the retaining structure 3 is composed by two connecting tenons 31, each of the connecting tenons 31 is in a reversed-T shape, and a neck section 32 is integratedly and downwardly extended from each of the lateral walls 12, the free end of each of the neck sections 32 is expanded so as to form a mounting section 33 whose size is larger and wider than the neck section 32, the outer edge of each of the mounting sections 33 is in an arc shape for more easily being mounted into an object to be retained.

As shown in FIG. 3, the object to be retained is a printed circuit board A, a lateral-sided T-shaped hole B is respectively provided on the printed circuit board A with respect to the corresponding connecting tenon 31, when combining, the two connecting tenons 31 are respectively inserted into a long hole B 1 of the T-shaped hole B and the sizes of the long holes B 1 are defined with respect to the sizes of the mounting sections 33, then the whole battery case is moved toward short holes B2 so the neck sections 32 are respectively received in the corresponding short holes B2, and the bottom ends of the lateral walls 12 and the inner sides of the mounting sections 33 are all retained on the printed circuit board A so a retaining effect is obtained. If the object to be retained is a sheet member with a thinner thickness, the two connecting tenons 31 are inserted into preset holes on the sheet member and a round-shaped connecting unit, e.g. a rubber band, is provided and is reeled on the two neck sections 32, a retaining effect is also achieved.

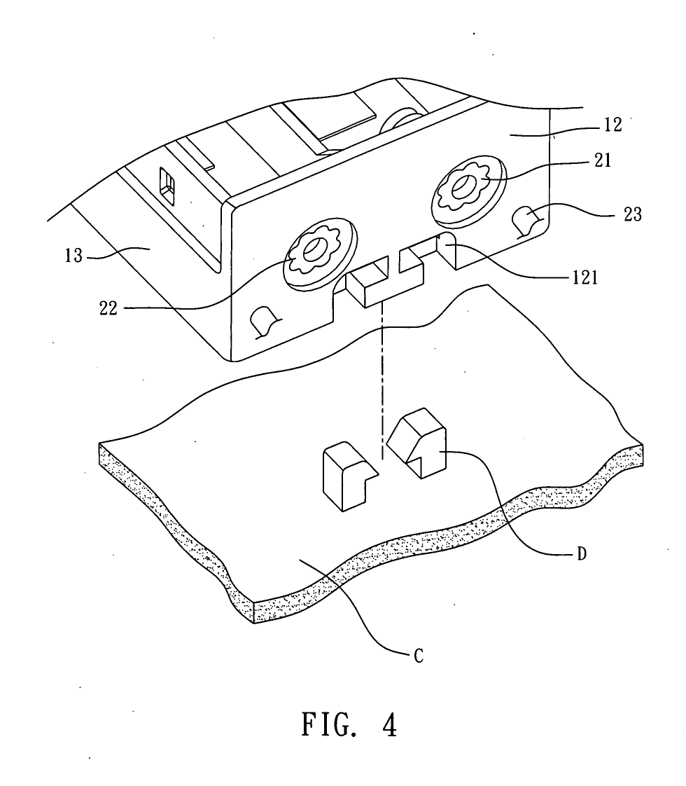

Referring to FIG. 4, which is another embodiment provided by the present invention, unlike the retaining structure 3 described at the previous embodiment which is extended from the bottom ends of the two lateral walls 12 of the case member 1, the retaining structure 3 provided in this embodiment is directly provided on the surfaces of the two lateral walls 12.

As shown in FIG. 4, an arc-shaped hollow hole 121 is respectively and inwardly provided at the bottom end of each of the lateral walls 12, a reversed-T-shaped connecting tenon 31 is downwardly and respectively extended from the top end of each of the hollow holes 121, each of the connecting tenons 31 is integratedly connected to the corresponding lateral wall 12 via a neck section 32, the bottom end of each of the connecting tenons 31 is provided with a mounting section 33 with a size larger and wider than the neck section 32, a gap is respectively formed between each of the hollow holes 121 and the two ends of the corresponding mounting section 33, an object to be retained, e.g. a sheet member C, is provided with a pair of buckling tenons D with respect to the two gaps, when being assembled, each of the buckling tenons D passes through the corresponding gap of the hollow hole 121, so a hooking section of each of the buckling tenons D is buckled in a concave space defined between the corresponding mounting section 33 and the neck section 32, thus an expected retaining effect is achieved.

The battery case provided by the present invention is equipped with a retaining structure on two lateral walls, the retaining structure is composed by two connecting tenons; with a buckling fashion each of the connecting tenons can be rapidly connected to an object to be retained, so there is no need of an external connecting unit, e.g. a screw, thus less human power and working hours are needed in operation and there is no screw to be seen in the battery case.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A battery case having retaining function, comprises:
a case member composed by a bottom wall, two lateral walls, a front wall and a rear wall so as to form a quadrangular space;
an electrode sheet set composed by at least one negative terminal and at least one positive terminal, the positive and the negative terminals are oppositely and respectively provided on the inner sides of the two lateral walls according to the circuit layout, wherein one of the negative terminals and one of the positive terminals are respectively connected to a connecting wire which is exposed outside of the case member;
a retaining structure composed by two connecting tenons, each of the connecting tenons includes a neck section integratedly and downwardly extended from the corresponding lateral wall, and the free end of each of the neck sections is provided with a mounting section with a size larger and wider than the neck section; by respectively mounting each of the connecting tenons into preset holes of an object to be retained, a retaining effect is obtained.

2. The battery case having retaining function as claimed in claim 1, wherein at least a partition rib is transversally provided between the two lateral walls for separating two adjacent batteries.

3. The battery case having retaining function as claimed in claim 1, wherein the top end of the rear wall is connected to a flexible top cover, a vertical bending edge is provided at the outer end of the top cover; when the top cover is covered on top of the opening portion of the case member, the bending edge is in contact with the front wall, and the bending edge and the front wall are buckled by a buckling unit provided between the bending edge and the front wall.

4. The battery case having retaining function as claimed in claim 3, wherein the buckling unit is composed by at least one buckling tenon and at least one buckling hole, and each of the buckling tenons can be buckled in the corresponding buckling hole.

5. The battery case having retaining function as claimed in claim 3, wherein the top end of the front wall is provided with a concave section having a size with respect to the size of the bending edge for being in contact with the bending edge.

6. The battery case having retaining function as claimed in claim 1, wherein the outer edge of each of the mounting sections is in an arc shape.

7. A battery case having retaining function, comprises:
a case member composed by a bottom wall, two lateral walls, a front wall and a rear wall so as to form a quadrangular space, and the bottom end of each of the lateral walls is inwardly provided with a hollow hole;
an electrode sheet set composed by at least one negative terminal and at least one positive terminal, the positive and the negative terminals are oppositely and respectively provided on the inner sides of the lateral walls according to the circuit layout, wherein one of the negative terminals and one of the positive terminals are respectively connected to a connecting wire which is exposed outside of the case member;
a retaining structure composed by two connecting tenons, each of the connecting tenons is provided in the corresponding hollow hole of the lateral wall, a neck section of each of the connecting tenons is served to connect to the corresponding lateral wall provided on top of the hollow hole, the free end below each of the neck sections is respectively provided with a mounting section with a size larger and wider than the neck section, a gap is formed respectively between each of the hollow holes and the two ends of the corresponding mounting section; by buckling plural buckling tenons preset on an object to be retained to the concave space defined between the mounting section and the neck section, a retaining effect is obtained.

8. The battery case having retaining function as claimed in claim 7, wherein at least a partition rib is transversally provided between the two lateral walls for separating two adjacent batteries.

9. The battery case having retaining function as claimed in claim 7, wherein the top end of the rear wall is connected to a flexible top cover, a vertical bending edge is provided at the outer end of the top cover; when the top cover is covered on top of the opening portion of the case member, the bending edge is in contact with the front wall, and the bending edge and the front wall are buckled by a buckling unit provided between the bending edge and the front wall.

10. The battery case having retaining function as claimed in claim 9, wherein the buckling unit is composed by at least one buckling tenon and at least one buckling hole, and each of the buckling tenons can be buckled in the corresponding buckling hole.

11. The battery case having retaining function as claimed in claim 9, wherein the top end of the front wall is provided with a concave section having a size with respect to the size of the bending edge for being in contact with the bending edge.
